(19) United States
(12) Patent Application Publication
(10) Pub. No.: US 2014/0194327 A1
(43) Pub. Date: Jul. 10, 2014

(54) VISCOUS FLUID SYSTEMS FROM WASTE WATER

(71) Applicants: Nathan R. Hutchings, Shreveport, LA (US); Sarkis R. Kakadjian, The Woodlands, TX (US); Mark H. Olive, Shreveport, LA (US); William J. Childs, Shreveport, LA (US); Amanda Rodriguez, Houston, TX (US); Joseph Earl Thompson, Houston, TX (US)

(72) Inventors: Nathan R. Hutchings, Shreveport, LA (US); Sarkis R. Kakadjian, The Woodlands, TX (US); Mark H. Olive, Shreveport, LA (US); William J. Childs, Shreveport, LA (US); Amanda Rodriguez, Houston, TX (US); Joseph Earl Thompson, Houston, TX (US)

(21) Appl. No.: 13/734,383

(22) Filed: Jan. 4, 2013

(51) Int. Cl. C09K 8/68

(52) U.S. Cl. CPC C09K 8/685
USPC 507/214; 507/200; 507/211; 507/259

(57) ABSTRACT

By including a chemical additive in the well treatment fluid system design the cost and environmental impact of hydraulic fracturing may be substantially reduced. By adding a weak base to the well treatment fluid, water having a high, heterogeneous concentration of dissolved solids, such as water produced by oil and gas wells, may be utilized as the base fluid for hydraulic fracturing or other stimulation processes without adversely affecting the various components of the well treatment fluid. The well treatment fluid typically includes a base fluid, in this case produced water, a gelling agent, a weak base, and other additives useful for treating a well such as friction reducers, buffering agents, clay control agents, biocides, scale inhibitors, chelating agents, gel-breakers, oxygen scavengers, antifoamers, crosslinkers, wax inhibitors, corrosion inhibitors, de-emulsifiers, foaming agents, or tracers.

### BACKGROUND

Hydraulic fracturing is a common and well-known enhancement method for stimulating the production of hydrocarbon bearing formations. The process involves injecting fluid down a wellbore at high pressure. The fracturing fluid is typically a mixture of water and proppant. The proppant may be made of natural materials or synthetic materials.

Generally the fracturing process includes pumping the fracturing fluid from the surface through a tubular. The tubular has been prepositioned in the wellbore to access the desired hydrocarbon formation. The tubular has been sealed both above and below the formation to isolate fluid flow either into or out of the desired formation and to prevent unwanted fluid loss. Pressure is then provided from the surface to the desired hydrocarbon formation in order to open a fissure or crack in the hydrocarbon formation.

Typically large amounts of fluid are required in a typical hydraulic fracturing operation. Additionally, chemicals are often added to the fluid along with proppant to aid in proppant transport, friction reduction, wettability, pH control and bacterial control. Typically, the fluid is mixed with the appropriate chemicals and proppant particulates and then pumped down the wellbore and into the cracks or fissures in the hydrocarbon formation.

Due to the large amounts of fluid required in a typical hydraulic fracturing operation as well as the ecological implications many operators would prefer to utilize the water that is produced by a well either during the drilling process or from other nearby wells. Produced water may be any water source that is produced from a geological reservoir that is unsuitable for use as potable water. Produced water often has a high, heterogeneous concentration of total dissolved solids, many of which are known to interfere with the stability and/or compatibility of hydraulic fracturing fluids. Typically produced water has a concentration of divalent cations greater than about 2000 parts per million or where the concentration of boron is greater than about 50 parts per million primarily consisting of various anions or cations.

The base fluids for cross-linked gel hydraulic fracturing fluid systems have historically been limited by the concentration of total dissolved solids or salts, the concentration of monovalent ions such as, but not limited to, sodium, potassium, bromide, bicarbonate, and chloride, and by the concentration of multivalent ions such as, but not limited, to calcium, magnesium, manganese, barium, strontium, iron, sulfate, or carbonate. Each of these factors negatively influences gel hydration rates, gel cross-linking efficiency, shear stability, and gel thermal stability. As pressure increases on the service companies and operators to find alternatives to the use of high quality water sources, such as fresh potable water, as the base fluid for their hydraulic fracturing operations, and as scrutiny is increasing over disposal practices for produced water and flowback, the pressure pumping marketing is ripe for new fracturing fluid additives or systems that will enable the use of lower quality or produced fluids with higher total dissolved solids as the base fluid.

### SUMMARY

One approach to enabling the use of oilfield wastewater or produced fluids as the base fluid for hydraulic fracturing that is becoming more prevalent is to design water treatment systems to recondition the low-quality source water streams into fluids that are compatible with existing fracturing fluid additives. Although there are some inherent merits to this approach, such as not having to change the fracturing system or gels and other additives or controlling the reintroduction of undesirable contaminants possibly including minerals into the well, there are also several significant limitations that are preventing this practice from becoming widespread. Among those limiting factors are, the additional transport and storage equipment required to handle wastewater multiple times, the increased cost associated with water treatment equipment and personnel, the inconsistent quality of treated water or treatment equipment performance resulting from changes in the wastewater chemistries and volumes over time, the cost and environmental risks associated with handling the concentrated secondary waste streams from the treatment process, and the fracturing system such as the gelling fluids and other additives may still be limited by the amount of total dissolved solids. Additionally, the reclaimed water quality typically continues to require freshwater to be blended with the reclaimed wastewater to meet the minimal quality requirements for the gel systems.

A newly emerging alternative approach that allows the use of produced and flowback water as the base fluid for hydraulic fracturing is to redesign the fracturing additives to overcome the historical limitations related to the use of low quality, high total dissolved solids, such as salt, as a base fluid. The inherent merits to this approach include the ability to move the wastewater straight from the source directly to the fracturing site, low cost associated with the treatment process, decreased sensitivity to the changes in wastewater quality that naturally occurs over time, no need to handle the concentrated final waste stream from the treatment process, and in areas where the operator has sufficient wastewater, there is no need to have redundant logistics in place to bring freshwater to the fracturing site.

A series of chemical additives have recently been formulated that, when added to a conventional guar-borate cross-linked gel system, carboxy methyl cellulose-zirconate system, or carboxy methyl hydroxyl propyl guar-zirconate system will promote cross-linking and gel thermal stability including scenarios where 100% untreated, undiluted produced saltwater is used as the base fluid. The system has been tested on produced and flowback water from the Bakken and Permian basin, both of which had over 300,000 ppm total dissolved solids and over 45,000 ppm total dissolved divalent cations.

An embodiment of the invention may include a well treatment material utilizing produced and flowback water, a viscosifying agent, a crosslinker, a buffering agent, and a weak base. The viscosifying agent may be present in an amount from about 8 pounds per thousand gallons of produced water to about 80 pounds per thousand gallons of produced water, more preferably the viscosifying agent may be present in an amount from about 15 pounds per thousand gallons of produced water to about 50 pounds per thousand gallons of produced water, and even more preferably the viscosifying agent is present in an amount from about 20 pounds per thousand gallons of produced water to about 45 pounds per thousand gallons of produced water. The crosslinker may be present in an amount from about 0.05 gallons per thousand gallons of produced water to about 4.0 gallons per thousand gallons of produced water, more preferably in an amount from about 1.0 gallons per thousand gallons of produced water to about 3.0 gallons per thousand gallons of produced water, and even more preferably in an amount from about 0.2 gallons per thousand gallons of produced water to about 2.0 gallons per thousand gallons of produced water. The weak base may be present in an amount from about 0.1 pounds per thousand gallons of produced water to about 50.0 pounds per thousand gallons of produced water, or more preferably in an amount from about 5.0 pounds per thousand gallons of produced water to about 40.0 pounds per thousand gallons of produced water. The viscosifying agent may be a cellulosic based polymer, a guar based polymer, a synthetic viscosifier, a sulfonated gelling agent, or a sulfonated polysaccharide. The weak base may have a pKa of from about 7.01 to about 13.00, or more preferably a pKa of from about 7.01 to about 10.50, and even more preferably a pKa of from about 7.01 to about 8.5.

In another embodiment of the invention the fracturing fluid utilizes produced water, a viscosifying agent, at least one material useful for treating a wellbore, and a weak base. The at least one material useful for treating a wellbore may be a friction reducer, a gelling agent, a clay control agent, a biocide, a scale inhibitor, a chelating agent, a gel-breaker, an oxygen scavenger, an antifoamer, a crosslinker, a wax inhibitor, a corrosion inhibitor, a de-emulsifier, a foaming agent, or a tracer. The fracturing fluid may utilize a viscosifying agent that may be present in an amount from about 8 pounds per thousand gallons of produced water to about 80 pounds per thousand gallons of produced water, or more preferably the viscosifying agent may be present in an amount from about 15 pounds per thousand gallons of produced water to about 50 pounds per thousand gallons of produced water, and even more preferably the viscosifying agent may be present in an amount from about 20 pounds per thousand gallons of produced water to about 45 pounds per thousand gallons of produced water. The fracturing fluid may utilize a crosslinker that may be present in an amount from about 0.05 gallons per thousand gallons of produced water to about 4.0 gallons per thousand gallons of produced water, or more preferably the crosslinker may be present in an amount from about 1.0 gallons per thousand gallons of produced water to about 3.0 gallons per thousand gallons of produced water, and even more preferably the crosslinker may be present in an amount from about 0.2 gallons per thousand gallons of produced water to about 2.0 gallons per thousand gallons of produced water. The fracturing fluid may utilize a weak base that may be present in an amount from about 0.1 pounds per thousand gallons of produced water to about 50.0 pounds per thousand gallons of produced water or more preferably the weak base is present in an amount from about 5.0 pounds per thousand gallons of produced water to about 40.0 pounds per thousand gallons of produced water. The viscosifying agent may be a cellulosic polymer, a guar, a synthetic viscosifier, a sulfonated gelling agent, or a sulfonated polysaccharide. The weak base may have a pKa of from about 7.01 to about 13.00, or more preferably the weak base may have a pKa of from about 7.01 to about 10.50, or even more preferably the weak base has a pKa of from about 7.01 to about 8.5.

### BRIEF DESCRIPTION OF THE DRAWINGS

FIG. 1 depicts the rheological profile of 20 pounds per thousand carboxy methyl hydroxyl propyl guar system at 260 degrees Fahrenheit.

FIG. 2 depicts rheological profile of 25 pounds per thousand carboxy methyl hydroxyl propyl guar system at 260 degrees Fahrenheit.

FIG. 3 depicts the water analysis of the tested water sample in FIGS. 1 and 2.

FIG. 4 depicts the rheological profile of 40 pounds per thousand carboxy methyl cellulose system at 260 degrees Fahrenheit.

FIG. 5 depicts the water analysis of the tested water sample in FIG. 4.

### DETAILED DESCRIPTION

The description that follows includes exemplary apparatus, methods, techniques, or instruction sequences that embody techniques of the inventive subject matter. However, it is understood that the described embodiments may be practiced without these specific details. Any references to produced water or flowback water should be understood to include either produced water or flowback water.

A viscosifying agent such as cellulosic polymers including but not limited to carboxyalkyl cellulose or carboxyalkyl cellulose crosslinked with transition metals like zirconate derivatives, titanate derivatives, and aluminate derivatives and combinations thereof may be used.

A viscosifying agents such as guar and derivatives including but not limited to carboxyalkyl guar like carboxy methyl hydroxyl propyl guar, hydroxyl propoyl guar, carboxy methyl guar and crosslinked guar and guar derivatives with borates, borates related crosslinkers, transition metals like zirconate derivatives, aluminate derivatives, and combinations thereof may be used. Other examples of such polymer include, without limitation, xanthan, scleroglucan and Welan gums.

A viscosifying agents such as synthetic viscosifiers may be acrylic and acrylamide polymers and copolymers, poly vinyl alcohols, ester and polyether crosslinked with borates, borates related crosslinkers, transition metals like zirconate derivatives, aluminate derivatives, and combinations thereof may be used.

A viscosifying agents such as sulfonated gelling agents which may be any sulfonated synthetic polymers including, but not necessarily limited to sulfonated polyvinyl alcohol, sulfonated polyacrylate, sulfonated polyacrylamide, acrylic acid copolymers or any combination thereof may be used.

A viscosifying agents such as sulfonated polysacharide which may be any sulfonated polysacharide including, but not necessarily limited to sulfonated galactomannan gums, sulfonated cellulose or any combination thereof may be used.

Typically the viscosifying agents, including but not limited to, carboxy methyl cellulose, guar, carboxy methyl hydroxyl propyl guar and others may be used in quantities as low as about 8 pounds per thousand gallons of produced water and as high as about 80 pounds per thousand gallons of produced water. Although a better range would be to use the viscosifying agent in quantities from about 15 pounds per thousand gallons of produced water to about 50 pounds per thousand gallons of produced water. The best range would be to use the viscosifying agent in quantities from about 20 pounds per thousand gallons of produced water to about 45 pounds per thousand gallons of produced water.

It has been found that a gel system may be used in conjunction with produced water where the above gel systems include a weak base with a pKa between about 7.01 and 12.00 that does not generate insoluble complexes with constituents in the waste water such as, but not limited to, amino alkyl alcohols when the weak base performs at least one of the following functions: (i) the weak base may act as the cross-linker activator for systems having a pH above about 7.5 pH; (ii) the weak base may act as a gel stabilizer by scavenging oxygenated or carbonated species; or (iii) the weak base may act as a component of the buffer system including where the buffer system is an organic acid.

It has been found that the gel stabilizing agents, including but not limited to, sodium thiosulphate and others may be used in quantities as low as about 0.1 pounds per thousand gallons of produced water and as high as about 10 pounds per thousand gallons of produced water. Although a better range would be to use the stabilizing agents in quantities from about 0.5 pounds per thousand gallons of produced water to about 6.0 pounds per thousand gallons of produced water. The best range would be to use the stabilizing agents in quantities from about 2.0 pounds per thousand gallons of produced water to about 4.0 pounds per thousand gallons of produced water.

It has been found that the weak bases, including but not limited to, 2-amino, 2 metyl propanol and others may be used in quantities as low as about 0.1 pounds per thousand gallons of produced water and as high as about 50 pounds per thousand gallons of produced water. Although the best range would be to use the weak bases in quantities from about 5.0 pounds per thousand gallons of produced water to about 40.0 pounds per thousand gallons of produced water.

It has been found that the crosslinking agent, including but not limited to, zirconium triethanolamine complexes, zirconium acetylacetonate, zirconium lactate, zirconium carbonate, and chelants of organic alphahydroxycorboxylic acid and zirconium can be used in concentrations as low as about 0.05 gallons per thousand gallons of produced water and as high as about 4.0 gallons per thousand gallons of produced water. Although a better range would be to use the crosslinking agent in quantities from about 0.1 gallons per thousand gallons of produced water to about 3.0 gallons per thousand gallons of produced water. The best range would be to use the crosslinking agent in quantities from about 0.2 gallons per thousand gallons of produced water to about 2.0 gallons per thousand gallons of produced water.

An alternative embodiment of the system may include the use of sulfonated biopolymers or sulfonated synthetic polymers where the buffer system disclosed above is used to create a cross-linked gel system where the base fluid has a high salt, high boron, or a high divalent cation concentration.

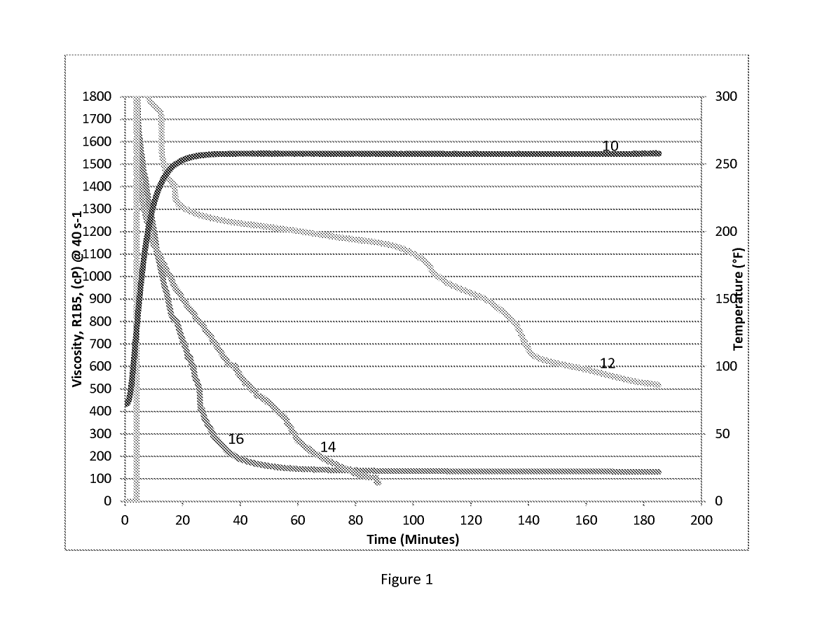

FIG. 1 depicts the rheological profiles of several gel systems using produced water (see FIG. 3) having twenty pounds per thousand (“PPT”) of a viscosifying agent such as carboxy methyl hydroxyl propyl guar at 260 degrees Fahrenheit. Each graphed line depicts the system in conjunction with a gel stabilizer, a weak base, a buffer, and a crosslinker. In FIG. 1 the temperature 10 rises rapidly to 260 degrees Fahrenheit and stabilizes at that temperature. Profile 16 depicts 4.0 gallons per thousand (“GPT”) of a gel stabilizer that is thirty percent by weight sodium thiosulphate, 0.5 GPT of a 99% (w/w) weak base such as 2 amino, 2 methyl propanol, 0.22 GPT of a crosslinker such as zirconate lactate with 5.1% w/w Zr and a pH modifier made of acetic acid giving a pH of 6.46. Profile 14 depicts 4.0 gallons per thousand (“GPT”) of a gel stabilizer that is thirty percent by weight sodium thiosulphate, 0.75 GPT of a weak base such as 2 amino 2 metyl propanol, 0.22 GPT of a crosslinker such as zirconate lactate and acetic acid giving a pH of 6.55. Profile 12 depicts 4.0 gallons per thousand (“GPT”) of a gel stabilizer that is thirty percent by weight sodium thiosulphate, 1.0 GPT of a weak base such as 2 amino, 2 methyl propanol, 0.22 GPT of a 5.1% w/w Zr in zirconium lactate and acetic acid giving a pH of 6.89.

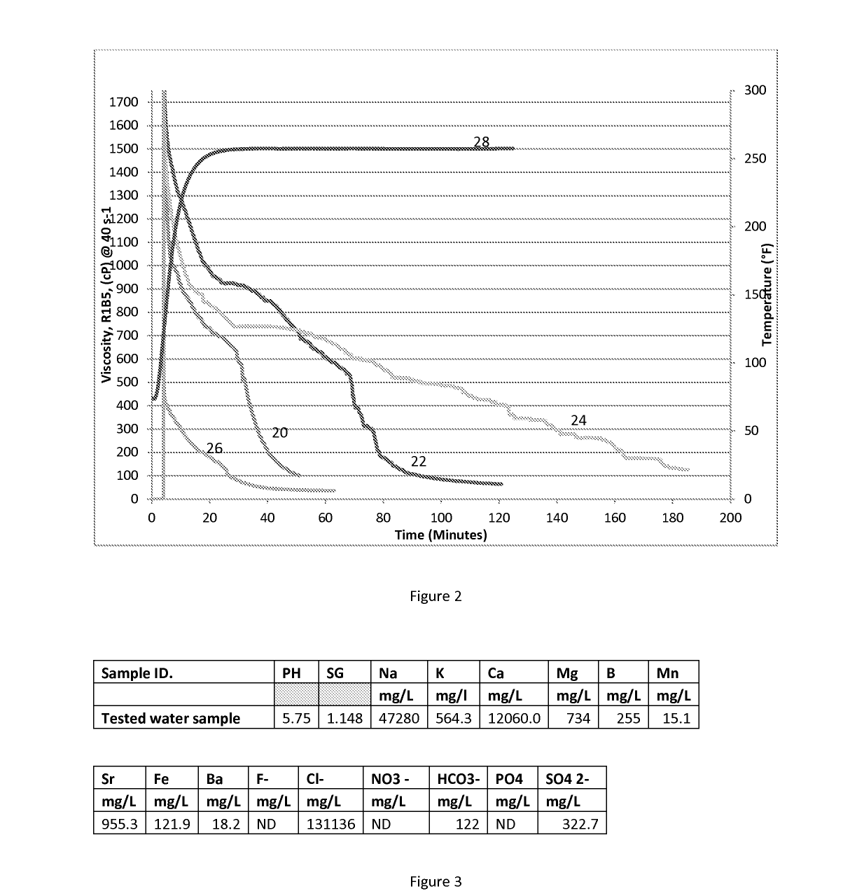

FIG. 2 depicts the rheological profiles of several gel systems using produced water (see also FIG. 3) having twenty five PPT of a viscosifying agent such as carboxy methyl hydroxyl propyl guar at 260 degrees Fahrenheit. Each graphed line depicts the system in conjunction with a gel stabilizer, a weak base, a pH modifier, and a crosslinker. In FIG. 2 the temperature 28 rises rapidly to 260 degrees Fahrenheit and stabilizes at that temperature. Profile 20 depicts 4.0 GPT of a gel stabilizer that is thirty percent by weight sodium thiosulphate, 0.25 GPT of a weak base such as 2 amino, 2 metyl propanol, 0.275 GPT of a crosslinker as 5.1% w/w Zr in zirconate lactate and acetic acid as pH modifier giving a pH of 6.27. Profile 22 depicts 4.0 gallons per thousand (“GPT”) of a gel stabilizer that is thirty percent by weight sodium thiosulphate, 0.5 GPT of a weak base such as 2 amino, 2 metyl propanol, 0.275 GPT of a crosslinker such as zirconate lactate with 5.1% w/w Zr and a pH modifier based in acetic acid giving a pH of 6.54. Profile 24 depicts 4.0 gallons per thousand (“GPT”) of a gel stabilizer that is thirty percent by weight sodium thiosulphate, 0.75 GPT of a weak base such as 2 amino, 2 metyl propanol, 0.275 GPT of a crosslinker with 5.1% w/w Zr in zirconate lactate and a pH modifier based in acetic acid giving a pH of 6.85. Profile 26 depicts 4.0 gallons per thousand (“GPT”) of a gel stabilizer that is thirty percent by weight sodium thiosulphate, 0.0 GPT of a weak base such as 2 amino, 2 metyl propanol, 0.275 GPT of a crosslinker of 5.1% w/w Zr in zirconate lactate and a pH modifier based in acetic acid giving a pH of 6.85.

FIG. 3 depicts the water analysis of the tested water sample used as the produced fluid in the rheological profiles in FIGS. 1 and 2.

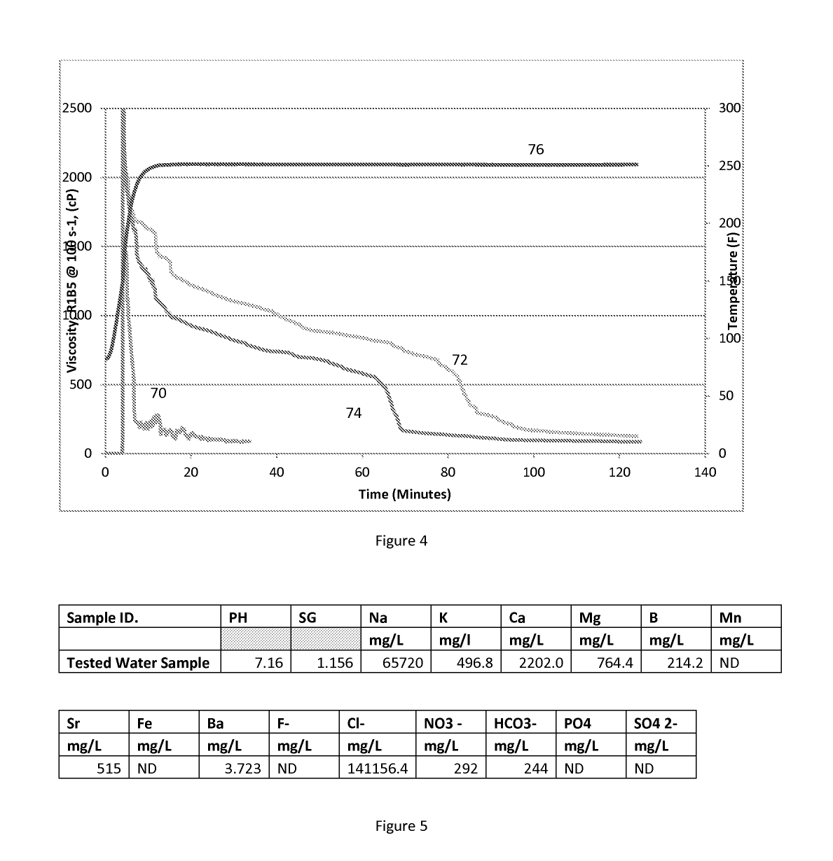

FIG. 4 depicts the rheological profiles of several gel systems using produced water (see also FIG. 5) having forty PPT of a viscosifying agent such as carboxy methyl cellulose at 260 degrees Fahrenheit. Each graphed line depicts the system in conjunction with a gel stabilizer, a weak base, a buffer, and a crosslinker. In FIG. 4 the temperature 76 rises rapidly to 260 degrees Fahrenheit and stabilizes at that temperature. Profile 70 depicts 5.0 GPT of a gel stabilizer that is thirty percent by weight sodium thiosulphate, 3.0 GPT of a crosslinker such as 5.1% w/w Zr in zirconate lactate and a pH modifier based in acetic acid giving a pH of 6.9. Profile 72 depicts 5.0 GPT of a gel stabilizer that is thirty percent by weight sodium thiosulphate, 5.0 GPT of a weak base such as 2 amino, 2 metyl propanol, 3.0 GPT of a crosslinker based in 5.1% w/w Zr in zirconate lactate and a pH modifier based in acetic acid giving a pH of 7.0. Profile 74 depicts 5.0 GPT of a gel stabilizer that is thirty percent by weight sodium thiosulphate, 2.0 GPT of a weak base such as 2 amino, 2 metyl propanol, 3.0 GPT of a crosslinker based in 5.1% w/w Zr in zirconate lactate and a pH modifier based in acetic acid giving a pH of 7.0.

FIG. 5 depicts the water analysis of the tested water sample used as the produced fluid in the rheological profiles in FIG. 4.

Polyacrylamide and polyacrylate polymers and copolymers are used typically as friction reducers at low concentrations for all temperatures ranges.

Present preferred gelling agents include guar gums, hydroxypropyl guar, carboxymethyl hydroxypropyl guar, carboxymethyl guar, and carboxymethyl hydroxyethyl cellulose. Suitable hydratable polymers may also include synthetic polymers, such as polyvinyl alcohol, polyacrylamides, poly-2-amino-2-methyl propane sulfonic acid, and various other synthetic polymers and copolymers. Other examples of such polymer include, without limitation, guar gums, high-molecular weight polysaccharides composed of mannose and galactose sugars, or guar derivatives such as hydropropyl guar (HPG), carboxymethyl guar (CMG). carboxymethylhydropropyl guar (CMHPG), hydroxyethylcellulose (HEC), hydroxypropylcellulose (HPC), carboxymethylhydroxyethylcellulose (CMHEC), xanthan, scleroglucan, polyacrylamide, polyacrylate polymers and copolymers.

Clay control additives may include the use of flax seed gum and up to 10,000 ppm of potassium or ammonium cations, the use of an acid salt of alkaline esters, the use of aliphatic hydroxyacids with between 2-6 carbon atoms, the use of cationic allyl ammonium halide salts, the use of poly allyl ammonium halide salts, the use of polyols containing at least 1 nitrogen atom preferably from a diamine, the use of primary diamine salt with a chain length of 8 or less, the use of quaternized trihydroxyalkylamines or choline derivatives, and the use of quaternary amine-based cationic polyelectrolyte and salts. The cation of the salts may be a divalent salt cation, a choline cation, or certain N-substituted quaternary ammonium salt cations.

Any desired non-oxidating biocide including aldehydes, quaternary phosphonium compounds, quaternary ammonium surfactants, cationic polymers, organic bromides, metronidazole, isothiazolones, isothiazolinones, thiones, organic thiocyanates, phenolics, alkylamines, diamines, triamines, dithiocarbamates, 2-(decylthio)ethanamine (DTEA) and its hydrochloride, and triazine derivatives.

Any desired oxidating biocides including hypochlorite and hypobromite salts, stabilized bromine chloride, hydroxyl radicals, chloramines, chlorine dioxide, chloroisocyanurates, halogen-containing hydantoins, and hydrogen peroxide and peracetic acid.

Scale control additives including chelating agents, may be Na, K or NH₄⁺ salts of EDTA; Na, K or NH₄⁺ salts of NTA; Na, K or NH.sub.4.sup.+ salts of Erythorbic acid; Na, K or NH.sub.4.sup.+ salts of thioglycolic acid (TGA); Na, K or NH.sub.4.sup.+ salts of Hydroxy acetic acid; Na, K or NH.sub.4.sup.+ salts of Citric acid; Na, K or NH.sub.4.sup.+ salts of Tartaric acid or other similar salts or mixtures or combinations thereof. Suitable additives that work on threshold effects, sequestrants, include, without limitation: Phosphates, e.g., sodium hexamethylphosphate, linear phosphate salts, salts of polyphosphoric acid, Phosphonates, e.g., nonionic such as HEDP (hydroxythylidene diphosphoric acid), PBTC (phosphoisobutane, tricarboxylic acid). Amino phosphonates of: MEA (monoethanolamine), NH.sub.3, EDA (ethylene diamine), Bishydroxyethylene diamine, Bisaminoethylether, DETA (diethylenetriamine), HMDA (hexamethylene diamine), Hyper homologues and isomers of HMDA, Polyamines of EDA and DETA, Diglycolamine and homologues, or similar polyamines or mixtures or combinations thereof; Phosphate esters, e.g., polyphosphoric acid esters or phosphorus pentoxide (P.sub.2O.sub.5) esters of: alkanol amines such as MEA, DEA, triethanol amine (TEA), Bishydroxyethylethylene diamine; ethoxylated alcohols, glycerin, glycols such as EG (ethylene glycol), propylene glycol, butylene glycol, hexylene glycol, trimethylol propane, pentaeryithrol, neopentyl glycol or the like; Tris & Tetrahydroxy amines; ethoxylated alkyl phenols (limited use due to toxicity problems), Ethoxylated amines such as monoamines such as MDEA and higher amines from 2 to 24 carbons atoms, diamines 2 to 24 carbons carbon atoms, or the like; Polymers, e.g., homopolymers of aspartic acid, soluble homopolymers of acrylic acid, copolymers of acrylic acid and methacrylic acid, terpolymers of acylates, AMPS, etc., hydrolyzed polyacrylamides, poly malic anhydride (PMA); or the like; or mixtures or combinations thereof.

A suitable crosslinking agent can be any compound that increases the viscosity of the fluid by chemical crosslinking, physical crosslinking, or any other mechanisms. For example, the gellation of a hydratable polymer can be achieved by crosslinking the polymer with metal ions including boron, zirconium, and titanium containing compounds, or mixtures thereof. One class of suitable crosslinking agents are organotitanates. Another class of suitable crosslinking agents are borates.

Typically gel-breakers are either oxidants or enzymes which operate to degrade the polymeric gel structure. Most degradation or “breaking” is caused by oxidizing agents, such as persulfate salts (used either as is or encapsulated), chromous salts, organic peroxides or alkaline earth or zinc peroxide salts, or by enzymes.

Presently preferred corrosion inhibitors include, but are not limited to quaternary ammonium salts such as chloride, bromides, iodides, dimethylsulfates, diethylsulfates, nitrites, bicarbonates, carbonates, hydroxides, alkoxides, or the like, or mixtures or combinations thereof; salts of nitrogen bases; or mixtures or combinations thereof. Quaternary ammonium salts include, without limitation, quaternary ammonium salts from an amine and a quaternarization agent, such as, alkylchlorides, alkylbromide, alkyl iodides, alkyl sulfates such as dimethyl sulfate, diethyl sulfate, etc., dihalogenated alkanes such as dichloroethane, dichloropropane, dichloroethyl ether, epichlorohydrin adducts of alcohols, ethoxylates, or the like; or mixtures or combinations thereof and an amine agent, such as, alkylpyridines, especially, highly alkylated alkylpyridines, alkyl quinolines, C6 to C24 synthetic tertiary amines, amines derived from natural products such as coconuts, or the like, dialkylsubstituted methyl amines, amines derived from the reaction of fatty acids or oils and polyamines, amidoimidazolines of DETA and fatty acids, imidazolines of ethylenediamine, imidazolines of diaminocyclohexane, imidazolines of aminoethylethylenediamine, pyrimidine of propane diamine and alkylated propene diamine, oxyalkylated mono and polyamines sufficient to convert all labile hydrogen atoms in the amines to oxygen containing groups, or the like or mixtures or combinations thereof. Salts of nitrogen bases, include, without limitation, salts of nitrogen bases derived from a salt, such as: C1 to C8 monocarboxylic acids such as formic acid, acetic acid, propanoic acid, butanoic acid, pentanoic acid, hexanoic acid, heptanoic acid, octanoic acid, 2-ethylhexanoic acid, or the like; C2 to C12 dicarboxylic acids, C2 to C12 unsaturated carboxylic acids and anhydrides, or the like; polyacids such as diglycolic acid, aspartic acid, citric acid, or the like; hydroxy acids such as lactic acid, itaconic acid, or the like; aryl and hydroxy aryl acids; naturally or synthetic amino acids; thioacids such as thioglycolic acid (TGA); free acid forms of phosphoric acid derivatives of glycol, ethoxylates, ethoxylated amine, or the like, and aminosulfonic acids; or mixtures or combinations thereof and an amine, such as: high molecular weight fatty acid amines such as cocoamine, tallow amines, or the like; oxyalkylated fatty acid amines; high molecular weight fatty acid polyamines (di, tri, tetra, or higher); oxyalkylated fatty acid polyamines; amino amides such as reaction products of carboxylic acid with polyamines where the equivalents of carboxylic acid is less than the equivalents of reactive amines and oxyalkylated derivatives thereof; fatty acid pyrimidines; monoimidazolines of EDA, DETA or higher ethylene amines, hexamethylene diamine (HMDA), tetramethylenediamine (TMDA), and higher analogs thereof; bisimidazolines, imidazolines of mono and polyorganic acids; oxazolines derived from monoethanol amine and fatty acids or oils, fatty acid ether amines, mono and bis amides of aminoethylpiperazine; GAA and TGA salts of the reaction products of crude tall oil or distilled tall oil with diethylene triamine; GAA and TGA salts of reaction products of dimer acids with mixtures of poly amines such as TMDA, HMDA and 1,2-diaminocyclohexane; TGA salt of imidazoline derived from DETA with tall oil fatty acids or soy bean oil, canola oil, or the like; or mixtures or combinations thereof.

Options for controlling oxygen content includes: (1) de-aeration of the fluid prior to downhole injection, (2) addition of normal sulfides to product sulfur oxides, but such sulfur oxides can accelerate acid attack on metal surfaces, (3) addition of erythorbates, ascorbates, diethylhydroxyamine or other oxygen reactive compounds that are added to the fluid prior to downhole injection; and (4) addition of corrosion inhibitors or metal passivation agents such as potassium (alkali) salts of esters of glycols, polyhydric alcohol ethyloxylates or other similar corrosion inhibitors. Examples include oxygen and corrosion inhibiting agents include mixtures of tetramethylene diamines, hexamethylene diamines, 1,2-diaminecyclohexane, amine heads, or reaction products of such amines with partial molar equivalents of aldehydes. Other oxygen control agents include salicylic and benzoic amides of polyamines, used especially in alkaline conditions, short chain acetylene dials or similar compounds, phosphate esters, borate glycerols, urea and thiourea salts of bisoxalidines or other compound that either absorb oxygen, react with oxygen or otherwise reduce or eliminate oxygen.

Agglomeration Agents include organo siloxanes, amines comprises aniline and alkyl anilines or mixtures of alkyl anilines, pyridines and alkyl pyridines or mixtures of alkyl pyridines, pyrrole and alkyl pyrroles or mixtures of alkyl pyrroles, piperidine and alkyl piperidines or mixtures of alkyl piperidines, pyrrolidine and alkyl pyrrolidines or mixtures of alkyl pyrrolidines, indole and alkyl indoles OF mixture of alkyl indoles, imidazole and alkyl imidazole or mixtures of alkyl imidazole, quinoline and alkyl quinone or mixture of alkyl quinoline, isoquinoline and alkyl isoquinoline or mixture of alkyl isoquinoline, pyrazine and alkyl pyrazine or mixture of alkyl pyrazine, quinoxaline and alkyl quinoxaline or mixture of alkyl quinoxaline, acridine and alkyl acridine or mixture of alkyl acridine, pyrimidine and alkyl pyrimidine or mixture of alkyl pyrimidine, quinazoline and alkyl quinazoline or mixture of alkyl quinazoline, or mixtures or combinations thereof. Additionally, amines comprise polymers and copolymers of vinyl pyridine, vinyl substituted pyridine, vinyl pyrrole, vinyl substituted pyrroles, vinyl piperidine, vinyl substituted piperidines, vinyl pyrrolidine, vinyl substituted pyrrolidines, vinyl indole, vinyl substituted indoles, vinyl imidazole, vinyl substituted imidazole, vinyl quinoline, vinyl substituted quinoline, vinyl isoquinoline, vinyl substituted isoquinoline, vinyl pyrazine, vinyl substituted pyrazine, vinyl quinoxaline, vinyl substituted quinoxaline, vinyl acridine, vinyl substituted acridine, vinyl pyrimidine, vinyl substituted pyrimidine, vinyl quinazoline, vinyl substituted quinazoline, or mixtures and combinations thereof.

Foaming Agents include suitable sodium salts of alpha olefin sulfonates (AOSs), include, without limitation, any alpha olefin sulfonate. Preferred AOSs including short chain alpha olefin sulfonates having between about 2 and about 10 carbon atoms, particularly, between 4 and 10 carbon atoms, longer chain alpha olefin sultanates having between about 10 and about 24 carbon atoms, particularly, between about 10 and 16 carbon atoms or mixtures or combinations thereof.

Suitable foam modifiers that can be used in place of or in conjunction with AOS include, cyclamic acid salts such as sodium (cyclamate), potassium, or the like, salts of sulfonated methyl esters having between about 12 and about 22 carbon atoms, where the salt is sodium, potassium, ammonium, alkylammonium, 2-aminoethanesulfonic acid (taurine) or the like such as Alpha-Step MC-48 from Stepan Corporation. Other additives include salts of 2-aminoethane sulfonic acids, where the salt is an alkali metal, ammonium, alkylammonium, or like counterions.

Suitable fatty acids include, lauric acid, oleic acid, stearic acid or the like or mixtures or combinations.

Suitable foam enhancers include, a foam enhancer selected from the group consisting of a linear dodecyl benzene sulfonic acid salt, a sarcosinate salt, and mixtures or combinations thereof. Preferred linear dodecyl benzene sulfonic acid salt include, ammonium linear dodecyl benzene sulfonic acid, alkylammonium linear dodecyl benzene sulfonic acid, alkanolamine ammonium linear dodecyl benzene sulfonic acid, lithium linear dodecyl benzene sulfonic acid, sodium linear dodecyl benzene sulfonic acid, potassium, cesium linear dodecyl benzene sulfonic acid, calcium linear dodecyl benzene sulfonic acid, magnesium linear dodecyl benzene sulfonic acid and mixtures or combinations thereof. Preferred sarcosinates include sodium lauryl sarcosinate, potassium lauryl sarcosinate, HAMPOSYL N-Acyl Sarcosinate Surfactants, Sodium N-Myristoyl Sarcosinate, and mixtures or combinations thereof.

Suitable additives for wax control include, cellosolves, cellosolve acetates, ketones, acetate and formate salts and esters, surfactants composed of ethoxylated or propoxylated alcohols, alkyl phenols, and/or amines, methylesters such as coconate, laurate, soyate or other naturally occurring methylesters of fatty acids; sulfonated methylesters such as sulfonated coconate, sulfonated laurate, sulfonated soyate or other sulfonated naturally occurring methyl esters of fatty acids; low molecular weight quaternary ammonium chlorides of coconut oils soy oils or C 10 to C24 amines or monohalogenated alkyl and aryl chlorides; quanternaryammonium salts composed of disubstituted (such as dicoco, etc.) and lower molecular weight halogenated alkyl and/or aryl chlorides, gemini quaternary salts of dialkyl (methyl, ethyl, propyl, mixed, etc.) tertiary amines and dihalogenated ethanes, propanes, etc. or dihalogenated ethers such as dichloroethyl ether (DCEE), or the like; gemini quaternary salts of alkyl amines or amidopropyl amines, such as cocoamidopropyldimethyl, bis quaternary ammonium salts of DCEE; or mixtures or combinations thereof. Suitable alcohols used in preparation of the surfactants include, without limitation, linear or branched alcohols, specially mixtures of alcohols reacted with ethylene oxide, propylene oxide or higher alkyleneoxide, where the resulting surfactants have a range of HLBs. Suitable alkylphenols used in preparation of the surfactants include, without limitation, nonylphenol, decylphenol, dodecylphenol or other alkylphenols where the alkyl group has between about 4 and about 30 carbon atoms. Suitable amines used in preparation of the surfactants include, without limitation, ethylene diamine (EDA), diethylenetriamine (DETA). OF other polyamines. Exemplary examples include Quadrols, Tetrols, Pentrols available from BASF. Suitable alkanolamines include, without limitation, monoethanolamine (MEA), diethanolamine (DEA), reactions products of MEA and/or DEA with coconut oils and acids.

De-emulsifier's include soap, naphtenic acid salts and alkylaryl sulphonate, sulphated castor oil petroleum sulphonates, derivatives of sulpho-acid oxidized castor oil and sulphosucinic acid ester, fatty acids, fatty alcohols, alkylphenols, ethylene oxide, propylene oxide copolymer, alkoxylated cyclic p-alkylphenol formaldehyde resins, amine alkoxylate, alkoxylated cyclic p-alkylphenol formaldehyde resins, polyesteramine and blends. Also included are antifoamers wherein the major constituent would include no-polar oils, such as minerals and silicones or polar oils such as fatty alcohols, fatty acids, alkyl amines and alkyl amides.

The surfactants may be, for instance, silanes, siloxanes, fluorosurfactants, fluorinated surfactants, dihydroxyl alkyl glycinate, alkyl ampho acetate or propionate, alkyl betaine, alkyl amidopropyl betaine and alkylamino mono- or di-propionates derived from certain waxes, fats and oils. Including, amphoteric/zwitterionic surfactants, in particular those comprising a betaine moiety.

Tracers may be a dye, fluorescer or other chemical which can be detected using spectroscopic analytical methods such as UV-visible, fluorescence or phosphorescence. Compounds of lanthanide elements may be used as tracers because they have distinctive spectra. A tracer may be a chemical with distinctive features which enables it to be distinguished by another analytical technique such as GC-MS. Such chemicals include fluorocarbons and fluoro-substituted aromatic acids. Radio-isotopes may be used as tracers. Salts of ions which do not occur naturally in subterranean reservoirs, such as iodides and thiocyanates may also be used as a tracer.

Weak bases include 2-hydroxy methyl pyperazine N′-4 butane sulphonic acid at about 8.3 pka; [tris(hydroxymethyl)methyl]amino propanesulphonic acid at about 8.4 pka; 2-amino, 2 methyl propanodiol at about 8.9 pka; N-trishyoroxymethyl-methyl-4-aminobutanesulfonic acid at about 8.9 pka; sulfate substituted amp at about 9.0 pka; 3-(cyclohexylamino)-1-ethanenesulfonic acid at about 9.0 pka; 3-(cyclohexylamino)-2-hydroxy-1-propanesulfonic acid at about 9.6 pka; 2 amino 2 methylpropanol at about 9.7 pka; 3-(cyclohexylamino)-1-propanesulfonic acid at about 10.4 pka; 10.7 pka 3-(cyclohexylamino)-1-batanesulfonic acid at about 10.7 pKa; N,N-bis(2-hydroxythyl-2-aminoethanesulphonic acid at about pKa=7.10; N,N-bis(2-hydroxyethyl)glycine at about pka=8.2; 1,3-bis[tris(hydroxymethyl)methylamino]propane at about 9.0 pka; 3-(cyclohexylamino)propanesulphonic acid at about 10.4 pka; 2-(cyclohexylamino)ethanesulphonic acid at about 9.3 pka; N-2-hydroxyethylpoperazine-N′-2-ethane-sulphonic acid at about 7.5 pka; N-2-hydroxycthylpiperazine-N′-3-propane-sulphonic acid at about 8.0 pka; 3-(N-morpholino)propanesulphonic acid at about 7.2 pka; piperazine-1,4-bis(2-hydroxypropanesulfonic acid) at about 7.8 pka; 3-[tris(hydroxymethyl)methyl]Amino propanesulphonic acid at about 8.4 pka; 2-[tris(hydroxymothyl)methyl]amino ethanesulphonic acid at about 7.5 pka; N-[tris(hydroxymethyl)methy]glycine at about 8.1 pka; tris(hydroxymethyl)aminomethane at about 8.1 pka.

In addition to the embodiments described above, the hydraulic fracturing fluid additives described above may also be included in the treatment chemistry. This list of additives is not exhaustive and additional additives known to those skilled in the art that are not specifically cited below fall within the scope of the invention

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A well treatment material comprising:
produced water, a viscosifying agent, a crosslinker, a buffering agent, and a weak base.

2. The well treatment material of claim 1 wherein the viscosifying agent is present in an amount from about 8 pounds per thousand gallons of produced water to about 80 pounds per thousand gallons of produced water.

3. The well treatment material of claim 1 wherein the viscosifying agent is present in an amount from about 15 pounds per thousand gallons of produced water to about 50 pounds per thousand gallons of produced water.

4. The well treatment material of claim 1 wherein the viscosifying agent is present in an amount from about 20 pounds per thousand gallons of produced water to about 45 pounds per thousand gallons of produced water.

5. The well treatment material of claim 1 wherein the crosslinker is present in an amount from about 0.05 gallons per thousand gallons of produced water to about 4.0 gallons per thousand gallons of produced water.

6. The well treatment material of claim 1 wherein the crosslinker is present in an amount from about 0.1 gallons per thousand gallons of produced water to about 3.0 gallons per thousand gallons of produced water.

7. The well treatment material of claim 1 wherein the crosslinker is present in an amount from about 0.2 gallons per thousand gallons of produced water to about 2.0 gallons per thousand gallons of produced water.

8. The well treatment material of claim 1 wherein the weak base is present in an amount from about 0.1 pounds per thousand gallons of produced water to about 50.0 pounds per thousand gallons of produced water.

9. The well treatment material of claim 1 wherein the weak base is present in an amount from about 5.0 pounds per thousand gallons of produced water to about 40.0 pounds per thousand gallons of produced water.

10. The well treatment material of claim 1 wherein the viscosifying agent is a cellulosic polymer.

11. The well treatment material of claim 1 wherein the viscosifying agent is a guar based polymer.

12. The well treatment material of claim 1 wherein the viscosifying agent is a synthetic viscosifier.

13. The well treatment material of claim 1 wherein the viscosifying agent is a sulfonated gelling agent.

14. The well treatment material of claim 1 wherein the viscosifying agent is a sulfonated polysaccharide.

15. The well treatment material of claim 1 wherein the weak base has a pKa of from about 7.01 to about 13.00.

16. The well treatment material of claim 1 wherein the weak base has a pKa of from about 7.01 to about 10.50.

17. The well treatment material of claim 1 wherein the weak base has a pKa of from about 7.01 to about 8.5

18. A fracturing fluid comprising produced water, a viscosifying agent, at least one material useful for treating a wellbore, and a weak base.

19. The fracturing fluid of claim 18 wherein at least one material useful for treating a wellbore is a friction reducer, a gelling agent, a clay control agent, a biocide, a scale inhibitor, a chelating agent, a gel-breaker, an oxygen scavenger, an antifoamer, a crosslinker, a wax inhibitor, a corrosion inhibitor, a de-emulsifier, a foaming agent, or a tracer.

20. The fracturing fluid of claim 18 wherein the viscosifying agent is present in an amount from about 8 pounds per thousand gallons of produced water to about 80 pounds per thousand gallons of produced water.

21. The fracturing fluid of claim 18 wherein the viscosifying agent is present in an amount from about 15 pounds per thousand gallons of produced water to about 50 pounds per thousand gallons of produced water.

22. The fracturing fluid of claim 18 wherein the viscosifying agent is present in an amount from about 20 pounds per thousand gallons of produced water to about 45 pounds per thousand gallons of produced water.

23. The fracturing fluid of claim 18 wherein the crosslinker is present in an amount from about 0.05 gallons per thousand gallons of produced water to about 4.0 gallons per thousand gallons of produced water.

24. The fracturing fluid of claim 18 wherein the crosslinker is present in an amount from about 1.0 gallons per thousand gallons of produced water to about 3.0 gallons per thousand gallons of produced water.

25. The fracturing fluid of claim 18 wherein the crosslinker is present in an amount from about 0.2 gallons per thousand gallons of produced water to about 2.0 gallons per thousand gallons of produced water.

26. The fracturing fluid of claim 18 wherein the weak base is present in an amount from about 0.1 pounds per thousand gallons of produced water to about 50.0 pounds per thousand gallons of produced water.

27. The fracturing fluid of claim 18 wherein the weak base is present in an amount from about 5.0 pounds per thousand gallons of produced water to about 40.0 pounds per thousand gallons of produced water.

28. The fracturing fluid of claim 18 wherein the viscosifying agent is a cellulosic polymer.

29. The fracturing fluid of claim 18 wherein the viscosifying agent is a guar based polymer.

30. The fracturing fluid of claim 18 wherein the viscosifying agent is a synthetic viscosifier.

31. The fracturing fluid of claim 18 wherein the viscosifying agent is a sulfonated gelling agent.

32. The fracturing fluid of claim 18 wherein the viscosifying agent is a sulfonated polysaccharide.

33. The fracturing fluid of claim 18 wherein the weak base has a pKa of from about 7.01 to about 13.00.

34. The fracturing fluid of claim 18 wherein the weak base has a pKa of from about 7.01 to about 10.50.

35. The fracturing fluid of claim 18 wherein the weak base has a pKa of from about 7.01 to about 8.5.
